(19) United States
(12) Patent Application Publication
(10) Pub. No.: US 2025/0084967 A1
(43) Pub. Date: Mar. 13, 2025

(54) PRESSURE VESSEL SYSTEM

(71) Applicant: Robert Bosch GmbH, Stuttgart (DE)

(72) Inventors: Armin Schuelke, Aidlingen (DE); Olaf Ohlhafer, Erligheim (DE)

(21) Appl. No.: 18/292,548

(22) PCT Filed: Jul. 29, 2022
(86) PCT No.: PCT/EP2022/071337

§ 371 Date: Jan. 26, 2024

(30) Foreign Application Priority Data
Aug. 26, 2021 (DE) 10 2021 209 366.3

(51) Int. Cl. F17C 13/12; B60K 15/03; F17C 13/02

(52) U.S. Cl. CPC F17C 13/12; B60K 15/03006; F17C 13/025; B60K 2015/0321; B60K 2015/03381; F17C 2221/012; F17C 2223/036; F17C 2250/043; F17C 2260/036; F17C 2260/042; F17C 2270/0178; F17C 2270/0184

(57) ABSTRACT

A pressure vessel system (21) for a motor vehicle, comprising at least two pressure vessels (19), each of which delimits an interior space (27), for filling with a fluid as fuel, a pressure sensor (32) for detecting the pressure in the pressure vessel system (21), and a computer unit (36) for determining a leak in the pressure vessel system (21) using the data detected by the pressure sensor (32), the pressure vessel system (21) comprising at least two pressure sensors for detecting the pressure of the fluid in at least two different pressure detection spaces (31) in the pressure vessel system (21), so that the pressure in each pressure detection space (31) can be detected by a pressure sensor (32) and, depending on the pressure data of the fluid in the at least two different pressure detection spaces (31) which can be detected by the at least two pressure sensors (32), a leak can be detected in the pressure vessel system (21), in particular in a pressure detection space (31).

### BACKGROUND

The present invention relates to a pressure vessel system, a method for operating a pressure vessel system, and a motor vehicle according to the disclosure.

Fuel cell units acting as galvanic cells convert continuously supplied fuel and an oxidizing agent into electrical energy by means of redox reactions at an anode and a cathode. Fuel cells are used in a wide variety of stationary and mobile applications, e.g., in homes without connection to a power grid or in motor vehicles, rail transport, aviation, space travel, and marine applications. A large number of fuel cells are stacked in the fuel cell unit to form the fuel cell stack. Channels for passing fuel, channels for passing oxidizers, and channels for guiding coolant are integrated into the fuel cell stack. The fuel is stored in a compressed gas reservoir. Multiple compressed gas reservoirs are in this case often combined as pressure vessels to form a pressure vessel system. The pressure vessel system therefore comprises pressure vessels and pressure lines. Leaks can occur in the pressure vessel system due to damage, ageing, corrosion, and vibration. Due to these leaks, fuel escapes from the pressure vessel system as a fluid, so unnecessary fuel consumption occurs with a small amount escaping per unit of time, and more fuel must be added when refueling. At larger discharge quantities per unit of time, the pressure vessels can therefore be completely emptied while the vehicle is in motion, making it impossible for the vehicle to continue its journey. In addition, fuel leakage poses a safety risk, especially if the vehicle is parked in a closed garage, because the fuel can be ignited in the closed garage.

DE 10 2015 219 766 A1 discloses a pressure vessel system for a motor vehicle powered by fuel gas, comprising: at least one pressure vessel for storing fuel gas; at least one pressure vessel valve; and at least one controller, the controller being designed to at least reduce the chronological rate of change of the fuel gas density in the pressure vessel given that a rate of change limit value for the chronological rate of change of the fuel gas density in the pressure vessel is exceeded.

DE 10 2016 204 073 A1 discloses a pressure vessel system comprising a pressure vessel for storing gas, the pressure vessel comprising a multi-shell structure and the volumes delimited by the respective shells being sealed off from one another in a substantially fluidically sealed manner, whereby a liquid is present at least in the volume between the outermost shell and the second-outermost shell, the pressure vessel system further comprising at least one pressure device for pressurizing the liquid.

### SUMMARY

The invention relates to a pressure vessel system for a motor vehicle, comprising at least two pressure vessels, each of which delimits an interior space, for filling with a fluid as fuel, a pressure sensor for detecting the pressure in the pressure vessel system, and a computer unit for determining a leak in the pressure vessel system using the data detected by the pressure sensor, the pressure vessel system preferably comprising at least two pressure sensors for detecting the pressure of the fluid in at least two different pressure detection spaces in the pressure vessel system, so that the pressure in each pressure detection space can be detected by a pressure sensor and, depending on the pressure data of the fluid in the at least two different pressure detection spaces which can be detected by the at least two pressure sensors, a leak can be detected in the pressure vessel system, in particular in a pressure detection space. Depending on the pressure data from the at least two pressure sensors in the at least 2 different pressure detection spaces, the leak in the respective pressure detection space can therefore be determined and detected. This enables the safe and reliable detection of leakage in pressure detection spaces. The leak in the pressure vessel in particular, which comprises the interior space as the pressure detection space, can thereby be detected.

In a further embodiment, the progression, in particular the change, of the pressure of the fluid in the at least two pressure detection spaces can be detected by the at least two pressure sensors depending on the time, and the leak in the pressure vessel system, in particular in one pressure detection space in each case, can be detected depending on the chronological progression of the pressure of the fluid in the at least two pressure detection spaces. Given a leak in a pressure detection space, the fluid flows constantly out of the leak, so the pressure in the pressure detection space is constantly reduced and the pressure progression can be calculated depending on the time. Without a leak in a pressure detection space, no fluid will flow out of the pressure detection space, so the pressure progression is substantially a straight line with a gradient of 0 with an additive constant corresponding to the pressure (y=m−t+n with m=0 and n equal to the substantially constant pressure), whereby the pressure may decrease slightly in the longer term due to diffusion. In particular, a leak in a pressure detection space is identified if the amount of reduction per unit of time of the pressure in the pressure detection space is greater than a reference value in comparison to a pressure detection space with an substantially constant pressure or an imaginary pressure detection space at an imaginary constant pressure. The chronological unit is preferably specified, e.g., 1 h, 3 h, 10 h, 1 d and/or 3 d. Different reference values are associated with different chronological units. As a parameter for the change in pressure depending on the time, e.g. the amount of pressure change, can be divided by the unit of time, and a leak in the pressure detection space is identified if a specified reference value for this pressure detection space is exceeded. The environment with an environment pressure or the average pressure in actual pressure detection spaces is preferably used as an imaginary pressure detection space.

In an additional embodiment, the pressure vessels, in particular all the pressure vessels, are connected to one another in a fluidically conducting manner by a connecting line, in particular a fuel line rail, and the connecting line delimits a flow space.

In an additional embodiment, the connecting line opens into a service valve as a closing element for directing the fluid to a conversion unit, in particular a fuel cell unit.

The pressure vessels preferably are each designed to comprise a fluid opening for releasing the fluid into and out of the pressure vessels through the fluid openings and the fluid openings of the pressure vessels, in particular all pressure vessels, can each be opened and closed using a shut-off element as a closing element. The pressure vessels preferably only comprise one fluid opening each, and no fluid can be introduced into or discharged from the pressure vessel when the shut-off element is closed.

In a further embodiment, the pressure detection spaces are the interior spaces delimited by the pressure vessels and/or the flow space delimited by the connecting line.

In an additional embodiment, the leak can be detected depending on the pressure data of the fluid of the at least two different pressure detection spaces, which can be detected by the at least two pressure sensors, by comparing the pressure, in particular the chronological pressure progression, in at least two different pressure detection spaces. The leak can be in particular be reliably inferred from the chronological pressure progression because, in the event of a leak, the fluid is continuously discharged from the pressure detection space, thus causing the pressure in the pressure detection space to decrease continuously. In particular, a leak in the pressure detection space is detected when the pressure in the pressure detection space is continuously reduced.

In an additional embodiment, the pressures, in particular the chronological pressure progression, are compared with one another in at least two different pressure detection spaces by comparing the difference in pressure, in particular the variation of the difference in chronological pressure progression, in the at least two different pressure detection spaces with at least one reference value, in particular multiple reference values, and the leak is detected in the event of a deviation from the at least one reference value, in particular multiple reference values. A deviation from the at least one reference value is considered to be, in particular, if the difference is greater than the reference value, i.e. exceeds it. Preferably, the amount of the difference is determined as the difference in pressure.

Advantageously, depending on the size of the deviation, a service notification, a warning, or an emergency message can be issued. These various notifications, i.e., the service notification, the warning, and the emergency message are identified selectively, e.g. by assigning a specific reference value to each notification. The corresponding notification can therefore be identified from the size of the determined difference using the corresponding different reference values for the different notes and output by the computer unit. In a motor vehicle, the information is, e.g., displayed on a visual and/or acoustic display device.

In a further embodiment, the pressure can be detected in the at least two pressure detection spaces while the closing elements opening into the at least two pressure detection spaces, in particular all closing elements opening into the at least two pressure detection spaces, are closed. The closing of the closing elements, which open into the at least two pressure detection spaces, is necessary so that no fluid is discharged from the pressure detection spaces during the detection of the pressure, because this would lead to a reduction of the pressure, so a leak would be detected which is not present because the discharge of the fluid due to the open closing element could be considered and detected as a leak.

In a further embodiment, the pressure vessel system comprises a drainage system for the at least one pressure vessel, which can be filled with the fluid, for releasing the fluid from the at least two pressure vessels into the environment when a specified limit value of a discharge parameter, in particular temperature and/or pressure, is exceeded.

The invention relates to a method for operating a pressure vessel system having a plurality of pressure vessels which delimit interior spaces as pressure detection spaces, for a motor vehicle, said method comprising the following steps: introducing a fluid as fuel through at least one fluid opening into at least one pressure vessel by opening at least one shut-off element for the at least one fluid opening, so that the at least one interior space of the at least one pressure vessel is filled with the fluid, releasing the fluid as fuel through the at least one fluid opening from at least one pressure vessel by opening the at least one shut-off element for the at least one fluid opening, so that the at least one interior space of the pressure vessel is emptied of the fluid, storing the fluid in the interior spaces of the pressure vessels by keeping the shut-off elements of the fluid openings of the pressure vessels closed during a storage period, detecting a pressure of the interior space of the pressure vessel using a pressure sensor, determining a leak in the pressure vessel system using the data detected by the pressure sensor by means of a computer unit, whereby, during a storage period, the closing elements, which are necessary for closing at least two pressure detection spaces, are always closed and, during the storage period, in these at least two pressure detection spaces the pressure of the fluid in the at least two pressure detection spaces is detected and, depending on the pressure data of the fluid in the at least two different pressure detection spaces, which data can be detected by the at least two pressure sensors, a leak can be detected in the pressure vessel system, in particular in each pressure detection space.

In an additional embodiment, the leak is detected depending on the pressure data detected by the at least two pressure sensors in the at least two different pressure detection spaces by comparing the pressure, in particular the chronological pressure progression, in the at least two different pressure detection spaces.

Temperature sensors are preferably used to detect the temperature of the fluid in the at least two different pressure detection spaces and the leak in the pressure vessel system is detected depending on the temperature data detected by the temperature sensors, in particular the chronological temperature progression. For example, an increase in pressure due to an increase in the temperature of a pressure vessel can therefore be detected by the temperature sensors and taken into account when determining the leak. When determining the difference between two pressure vessels, a pressure vessel with an increase in pressure due to a locally increased temperature at the pressure vessel is therefore not taken into account when determining the leak, or the pressure can be corrected using the identified temperature.

The motor vehicle according to the invention comprises a vehicle body, a plurality of wheels, a pressure vessel system, at least one conversion unit as a fuel cell unit, and/or an internal combustion engine, which can be operated using the combustible fluid from the pressure vessel system in order to convert electrochemical energy of the combustible fluid into electrical and/or mechanical energy, the pressure vessel system being designed as a pressure vessel system described in the present patent application and/or a method described in the present patent application can be performed using the motor vehicle.

Temperature sensors are used to detect the temperature of the fluid in at least one pressure detection space, in particular at least two different pressure detection spaces, and, depending on the temperature data detected by the at least one temperature sensor, in particular the temperature sensors, in particular the chronological temperature progression, preferably when a limit value is exceeded, an external heat source, for example a fire, is detected as a hazardous situation and preferably a hazard warning is emitted, in particular acoustically and/or optically.

In an additional embodiment, the pressure vessel system described in the present patent application can be used to perform the method described in the present patent application.

In an additional embodiment, the method described in the present patent application is performed using the pressure vessel system described in the present patent application.

In a further embodiment, the pressure vessels are designed to comprise only one fluid opening each for releasing the fluid into and out of the pressure vessels through the fluid openings.

In a further embodiment, the pressure vessels are each enclosed by a fluidically sealed casing, so that an interspace is formed between each casing and each pressure vessel and the interspaces between the pressure vessels and the casings are the pressure detection spaces.

In an additional embodiment, the pressure vessels are enclosed by a, in particular only one, fluidically sealed housing, so that the interspace between the housing and the pressure vessels is the pressure detection space.

In a further embodiment, the detection of the pressure of the fluid in the pressure vessel system in the at least two pressure detection spaces of the pressure vessel system can be detected using absolute pressure sensors, so that in particular the pressure data detected by the absolute pressure sensors can be compared and/or can be detected using at least one relative pressure sensor for each two pressure detection spaces in that the at least one relative pressure sensor is connected in a fluidically conducting manner to each of the at least two pressure detection spaces.

The one pressure detection space is a pressure detection space whose pressure data has been detected in order to detect the leak.

In an additional embodiment, the leak in one of each of these at least two pressure detection spaces is detected from the pressure data of at least two pressure detection spaces.

The fuel cell system according to the invention, in particular for a motor vehicle, comprises a fuel cell unit, a pressure vessel system, and preferably a drainage system for the at least one pressure vessel, which can be filled with the fluid, in order to discharge the combustible fluid from the at least one pressure vessel into the ambient environment when a specified limit value of the discharge parameter is exceeded, a gas conveying device for conveying a gaseous oxidizing agent to the cathodes of the fuel cells, in which case the pressure vessel system is designed as a pressure vessel system described in the present patent application.

Regarding the drainage system in particular, the discharge parameter for controlling and/or regulating the at least one discharge valve, in particular TPRD, is the temperature of the fluid in the pressure vessel and/or the temperature of the at least one discharge valve and/or the pressure of the fluid in the pressure vessel. Preferably, when the specified limit value of the temperature and/or the specified limit value of the pressure of the pressure vessel and/or the fluid in the pressure vessel and/or the temperature of the at least one discharge valve is exceeded, it is therefore possible to open the at least one discharge valve so that the fluid can be discharged from the at least one discharge opening. The discharge parameter can preferably be detected separately for each pressure vessel, and the control and/or regulation, in particular the opening of the respective discharge valve associated with the respective pressure vessel, takes place depending on the discharge parameter detected for said respective pressure vessel. The discharge parameter preferably comprises two partial discharge parameters, specifically temperature and pressure.

In an additional embodiment, the drainage system comprises a service valve.

The fluid is preferably a gas, in particular hydrogen.

The service valve can preferably be actively closed and opened, in particular by means of an electromagnet, and preferably depending on the operating state of the fuel cell unit. During operation of the conversion unit, in particular the fuel cell unit, the service valve is therefore open and in a switched-off operating state of the conversion unit, in particular the fuel cell unit, the service valve is closed.

In an additional embodiment, the fuel cell unit comprises a housing and/or a connection plate.

In a further embodiment, the fuel cell unit comprises at least one connection device, in particular multiple connection devices, as well as tensioning elements for pretensioning the fuel cell stack with a compressive force.

In a further embodiment, the fuel cells each comprise a proton exchange membrane, an anode, a cathode, at least one gas diffusion layer, and at least one bipolar plate.

In a further embodiment, the connecting device is designed as a bolt and/or is rod-shaped.

The tensioning elements are advantageously designed as clamping plates.

In a further embodiment, the gas conveying device is designed as a blower or a compressor.

Preferably, the fuel is hydrogen, hydrogen-rich gas, reformate gas, or natural gas.

Advantageously, the fuel cells and/or components are designed to be substantially flat and/or disk-shaped.

In an additional embodiment, the oxidizer is air, comprising oxygen or pure oxygen.

The fuel cell unit is preferably a PEM fuel cell unit comprising PEM fuel cells.

### BRIEF DESCRIPTION OF THE DRAWINGS

Exemplary embodiments of the invention are explained in greater detail hereinafter with reference to the accompanying drawings. Shown are:

FIG. 1 a cross-section of a pressure vessel system comprising three pressure vessels in a first exemplary embodiment,

FIG. 2 a longitudinal section of the pressure vessel according to FIG. 1

FIG. 3 a highly simplified illustration of a fuel cell system comprising a fuel cell unit and a pressure vessel system,

FIG. 4 a longitudinal section of a pressure vessel in a second exemplary embodiment,

FIG. 5 a highly simplified representation of a pressure vessel system in a second exemplary embodiment, and

FIG. 6 a perspective view of a motor vehicle.

### DETAILED DESCRIPTION

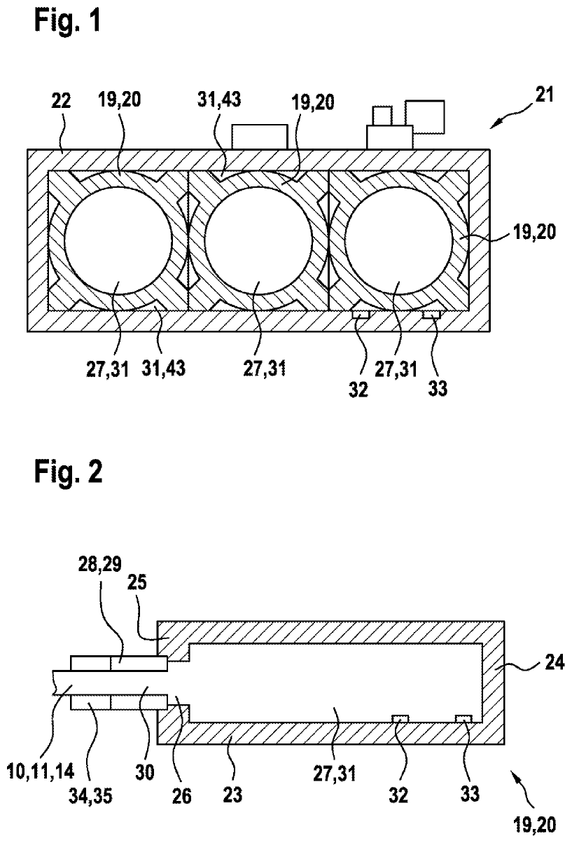

FIG. 1 shows a pressure vessel system 21, and FIG. 2 shows a longitudinal section of a pressure vessel 19 as a compressed gas reservoir 20. In the compressed gas reservoir 20, a fluid, specifically the gas (hydrogen) as fuel, is stored under a pressure of approximately 400 to 800 bar in an interior space 27 of the pressure vessel 19. The interior space 27 is delimited by a cylindrical vessel side wall 23, a substantially disk-shaped rear wall 24 and a front wall 25, which is also substantially disk-shaped. The vessel side wall 23, the rear wall 24, and the front wall 25 are in this case made of metal, in particular steel or a fiber-reinforced plastic. A fluid opening 26 is formed in the front wall 25. In the area of the fluid opening 26 of the front wall 25, a discharge valve 28 is attached as a TPRD 29 (temperature pressure relief device). The discharge valve 28 comprises an admission opening 30 and the fluid opening 26 of the front wall 25 opens into the admission opening 30. Furthermore, the discharge valve 28 is connected to the front wall 25 in a fluidically sealed manner. When only a specified limit value of a discharge parameter of the discharge valve 28 is exceeded, i.e., the drainage parameter of a specified pressure of the fluid in the interior space 27 and a specified temperature of the discharge valve 28, the discharge valve 28 opens and discharges the fluid from the interior space 27 of the pressure vessel 19 into the environment for safety reasons in order to prevent a dangerous overpressure and avoid an explosion. The discharge valve 28 is connected to the front wall 25 of the pressure vessel 19 in a thermally conductive manner, so the temperature of the fluid in the interior space 27 substantially corresponds to the temperature of the discharge valve 28. The specified temperature of the discharge parameter is, e.g., 120° C. or 200° C., and the specified pressure of the discharge parameter at a maximum permissible operating pressure of the pressure vessel 19 of 800 bar is 850 bar. In other words, if the maximum permissible operating pressure of the pressure vessel 19 is exceeded by 50 bar, then the discharge valve 28 is opened. In the pressure vessel system 21 shown in FIG. 1, three pressure vessels 19 are arranged and enclosed by a substantially rectangular housing 22. The housing 22 is designed to be fluidically sealed. An interspace 43 is thereby formed between the housing 22 and the pressure vessels 19. The discharge valves 28 (not shown in FIG. 1) in this case form a drainage system 41.

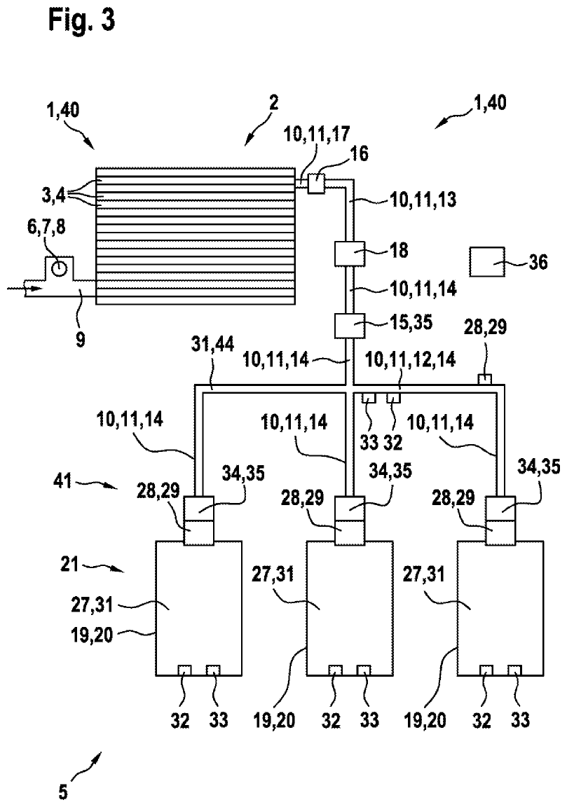

The interior space 27 of the pressure vessel 19 is connected to a pressure line 10 as a fuel line 11 for releasing the fluid from the pressure vessel 19 for normal operation of a fuel cell unit 1 (FIG. 3). FIG. 3 shows a fuel cell system 5 comprising the pressure vessel system 21 and the fuel cell unit 1. The fuel cell unit 1 comprises a fuel cell stack 2 as a fuel cell stack 2, and the fuel cell stack 2 is enclosed by a housing (not shown) and preferably a connection plate (not shown). A large number of fuel cells 3, i.e. PEM fuel cells 4, are stacked in the fuel cell stack 2. Due to the large number of stacked fuel cells 3 of approximately 300 to 400 fuel cells 3, not all of them are shown in FIG. 3 for reasons of simplification. Formed in the fuel cell stack 2 are channels for the passage of the fuel (hydrogen), channels for the passage of the oxidizer (air), and channels for the passage of the coolant (not shown). The hydrogen fuel is fed to the anodes and the oxidizer air is fed to the cathodes of the fuel cells 3. The oxidizer (air) is introduced from the ambient air into the fuel cell stack 2 via a supply line 9 and a gas conveying device 6, e.g. a blower 7 or a compressor 8.

The hydrogen fuel is fed from the pressure vessel system 21 into the fuel cell stack 2 through a supply line 17. A shut-off element 34 is arranged on each pressure vessel 19 as a closing element 35 in the area of the discharge valve 28. The shut-off element 34 is used to separately close and open the individual pressure vessels 19. The shut-off element 34 is, e.g., designed as a closing valve that can be actuated using an electromagnet as an actuator. To feed the fuel from the pressure vessels 19 to the fuel cell stack 2, only individual pressure vessels 19 or only one pressure vessel 19 can therefore be used to discharge the fuel to the fuel cell stack 2, depending on the closed state of the shut-off element 34. At least one pressure vessel 19 can thereby be selectively selected for releasing the fuel to the fuel cell stack 2, so that after the at least one selectively selected pressure vessel 19 has been completely emptied, the at least one shut-off element 34 on the emptied pressure vessel 19 is closed and the at least one other shut-off element on at least one other pressure vessel 19 is opened for emptying these other pressure vessels 19. In contrast, all shut-off elements 34 can also be opened simultaneously to empty the pressure vessel system 21, so that all pressure vessels 19 are emptied simultaneously during operation of the fuel cell stack 2. The “closing element” 35 is a generic term referring to the shut-off element 34 on the pressure vessels 19 and the service valve 15.

The fuel line 11 connected to the discharge valve 28 as pressure line 10 in each case at the pressure vessels 19 initially flows into a fuel line rail 12 as connecting line 12, which also forms a pressure line 10. A discharge valve 28 is also installed in the fuel line rail 12 as a TPRD 29. The fuel line rail 12 delimits a flow space 44 for passing the fluid as the hydrogen fuel. From the fuel line rail 12, the fuel is fed from the 3 pressure vessels 19 through a high-pressure line 14 at a pressure of approximately 800 bar to an service valve 15 and from the service valve 15 through a further high-pressure line 14 to a pressure reducer 18. The service valve 15 only opens when the fuel cell unit 1 is in operation and the service valve 15 is closed when the fuel cell unit 1 is switched off. In the pressure reducer 18, the pressure of the fuel in a medium-pressure line 13 is reduced by approximately 10 bar to 20 bar. The fuel is fed from the medium pressure line 13 to an injector 16 or a metering valve 16. At the injector 16, the pressure of the fuel is reduced to an injection pressure of between 1 bar and 3 bar. The fuel is supplied from the injector 16 to the fuel supply line 17 (FIG. 3) and from the supply line 17 to the fuel channels of the fuel cell stack 2.

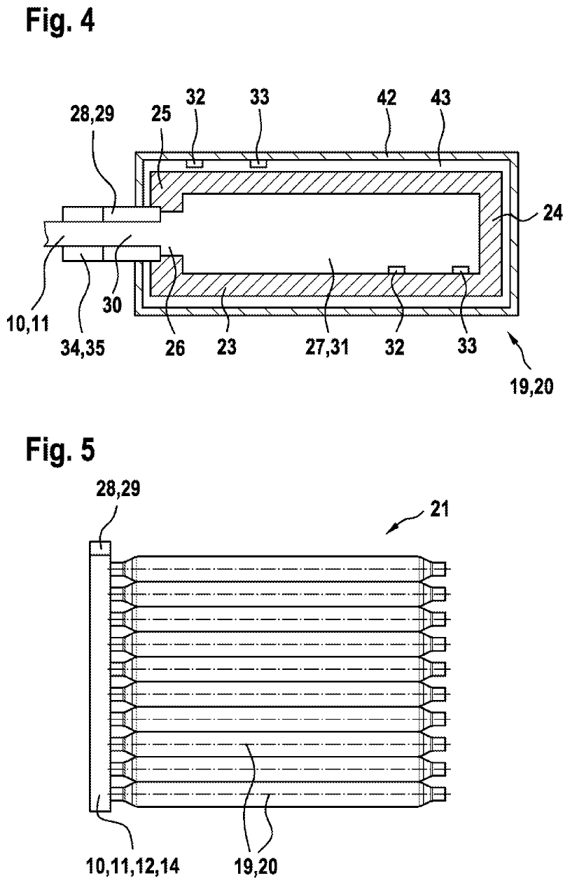

FIG. 4 shows a second exemplary embodiment of the pressure vessel 19. The pressure vessel 19, i.e. the vessel side wall 23, the rear wall 24 and the front wall 25 of the pressure vessel 19, is additionally surrounded by a fluidically sealed casing 42 made of metal or plastic, in particular fiber-reinforced plastic. The interspace 43 is therefore formed between the pressure vessel 19 and the casing 42. The interspace 43 is fluidically sealed with respect to the ambient environment.

The interior spaces 27 of the pressure vessels 19, the flow space 44 of the fuel line rail 12, the interspace 43 between the pressure vessel 19 and the casing 42 and the interspace 43 between the pressure vessels 19 and the housing 22 each form a pressure detection space 31. In the pressure vessel system 21, a pressure sensor 32 and a temperature sensor 33 are arranged at each pressure detection space 31. The pressure and temperature can thereby be detected independently of each other for all of the pressure detection spaces 31. The pressure data detected by the pressure sensors 32 and the temperature data detected by the temperature sensors 33 are transmitted via data lines (not shown) to a computer unit 36 as a control and/or regulating unit 36 and evaluated. In the computer unit 36, during a storage period of the pressure vessels 19, in which all shut-off elements 34 on the pressure vessels 19 are closed, the progression of the pressure in the pressure vessels 19 is detected and evaluated by comparing the pressure, in particular the progression of the pressure, in the pressure vessels 19 with one another. The difference in pressure in the interior spaces 19 between different pressure vessels 19 is in this case identified and compared with reference values. If there is a deviation from the reference values, then a leak in a pressure vessel 19 is detected. For example, the reference value is 10 bar and if the difference in the pressure of the fuel in the interior spaces 27 of two pressure vessels 19 deviates from the reference value after a specified period of time, a leak is detected in the pressure vessel 19 with the lower pressure. The amount of the difference in pressure in the two pressure vessels 19 is determined as the difference. A deviation from the reference value is therefore considered to be an excess of the identified amount of the difference from the reference value. The reference value for the leak can in this case also be changed and adjusted using empirical criteria during operation of the pressure vessel system 21 using algorithms in the computer unit 36. In addition, reference values with different variables can also be stored in the computer unit 36, so that different notifications are issued when the values deviate from the different reference values, for example a service notification, a warning or an emergency message. By comparing the pressures in the pressure detection spaces 31, in particular the interior spaces 27 of the pressure vessels 19, it is therefore possible to draw conclusions about a leak in a single pressure vessel 19 or in multiple pressure vessels 19.

In contrast, the difference in the pressure of the fuel can be determined by detecting the difference between the pressure in only one pressure vessel 19 and the average pressure in all other pressure vessels 19, in particular the average pressure in all other pressure vessels 19, without detecting the only one pressure vessel 19, the leak from which is intended to be identified.

This procedure can, as described hereinabove, can also be performed in order to determine a leak in the flow space 44 in the form of the pressure detection space 31 of the fuel line rail 12. During the storage period, all closing elements 35, i.e., the service valve 15 and all shut-off elements 34 on the pressure vessel 19 are closed so that, in the event of a leak in the flow space 44, i.e. the fuel line rail 12, the pressure of the fuel in the flow space 44 decreases steadily and sharply and, if the pressure vessels 19 are sealed, the pressure in the pressure vessels 19 remains constant. The difference between the pressure in the flow space 44 and the pressure in at least one interior space 27 of at least one pressure vessel 19 is thereby used to detect the leak in the flow space 44. In particular, the average pressure in all pressure vessels 19 can in this case also be used to determine the difference.

A leak in the pressure vessel 19 as shown in FIG. 4 leads to an increase in pressure in the interspace 43 comprising the leaking pressure vessel 19. The difference between the pressure in the interspace 43 and the pressure in the interspace 43 before the increase in pressure or to the ambient pressure is in this case determined in order to detect the leak in a pressure vessel 19 in the interspace 43. If multiple pressure vessels 19 are provided in the interspace 43, then only the leak in at least one pressure vessel 19 in the interspace 43 can be inferred, and cannot be determined which of the pressure vessels 19 in the interspace 43 has a leak. The procedure described hereinabove can therefore also be used to detect a leak in pressure vessels 19 in the interspace 43 as shown in FIG. 1.

To detect the leak in a pressure detection space 31, not only the pressure data from the pressure sensors 32 are optionally used, but also the temperature data from the temperature sensors 33 at the pressure detection spaces 31, and additionally from a temperature sensor (not shown) for detecting the ambient temperature. A local temperature increase at only one pressure vessel 19 causes an increase in the pressure in the only one pressure vessel 19 due to the higher temperature of the pressure vessel 19, and this can be determined quantitatively using the general gas equation. In the computer unit 36, such an increased pressure in the pressure vessel 19 due to a local temperature increase is taken into account so that no errors result for the detection of the leak. In addition, by detecting the temperatures separately at the pressure vessels 19, hazard warnings can also be issued due to the locally increased temperature.

The highly simplified pressure vessel system 21 shown in FIG. 5 comprises a large number of pressure vessels 19 with a small diameter and a low overall height, so that the pressure vessel system 21 with a low overall height can also be fastened in a motor vehicle 37 on the underside under the vehicle body 39 of the motor vehicle 37.

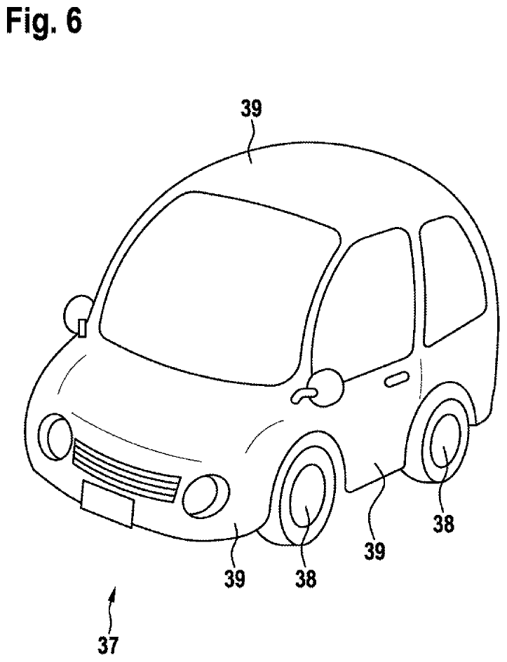

A motor vehicle 37 shown in FIG. 6 is, e.g., a passenger car or truck comprising a vehicle body 39 and four wheels 38. The fuel cell system 5 shown in FIG. 3 comprising the fuel cell unit 1 and the pressure vessel system 21 is installed in the motor vehicle 37. The fuel cell unit 1 converts the electrochemical energy present in the fuel (hydrogen) into electrical energy. The electrical energy as electrical current, which is generated by the fuel cell unit 1, is used in the motor vehicle 37 in particular to supply electrical energy to a drive motor as a traction electric motor for traction and for driving the motor vehicle 37. The pressure vessel system 21 is attached underneath the vehicle body 39 of the motor vehicle 37.

Overall, the pressure vessel system 21 according to the invention, the method according to the invention for operating the pressure vessel system 21, and the motor vehicle 37 according to the invention provide significant advantages. The pressure data and temperature data detected in the pressure detection spaces 31, in particular the interior spaces 27 of the pressure vessels 19 and the flow space 44 of the fuel line rail 12, are evaluated in the computer unit 36 and the leak in the pressure detection spaces 31, and thus the leak in the pressure vessels 19, can be inferred based on a comparison, in particular the pressure progression depending on time. This makes it possible to provide targeted information, thereby significantly improving the safety of the pressure vessel system 21. This is particularly advantageous when the pressure vessel system 21 is used in motor vehicles 37.

1. A pressure vessel system (21) for a motor vehicle (37), comprising:
at least two pressure vessels (19), each of which delimits an interior space (27), for filling with a fluid as fuel,
a pressure sensor (32) for detecting a pressure in the pressure vessel system (21),
a computer unit (36) for determining a leak in the pressure vessel system (21) using data detected by the pressure sensor (32),
wherein
the pressure vessel system (21) comprises at least two pressure sensors for detecting the pressure of the fluid in at least two different pressure detection spaces (31) in the pressure vessel system (21), so that the pressure in each pressure detection space (31) can be detected by a pressure sensor (32) and, depending on pressure data of the fluid in the at least two different pressure detection spaces (31), which data can be detected by the at least two pressure sensors (32), a leak can be detected in the pressure vessel system (21).

2. The pressure vessel system according to claim 1,
wherein
a progression of the pressure of the fluid in the at least two pressure detection spaces (31) can be detected by the at least two pressure sensors (32) depending on time, and the leak in the pressure vessel system (21) can be detected depending on a chronological progression of the pressure of the fluid in the at least two pressure detection spaces (31).

3. The pressure vessel system according to claim 1,
wherein
the pressure vessels (19) are connected to one another in a fluidically conducting manner by a connecting line (12) and the connecting line (12) delimits a flow space (44).

4. The pressure vessel system according to claim 3,
wherein
the connecting line (12) opens into a service valve (15) as a closing element (35) for conducting the fluid to a conversion unit (40).

5. The pressure vessel system according to claim 1,
wherein
the pressure vessels (19) are each configured to comprise a fluid opening (26) for introducing and releasing the fluid into and out of the pressure vessels (19) through the fluid openings (26), and the fluid openings (26) of the pressure vessels (19) can each be opened and closed by a shut-off element (34) as a closing element (35).

6. The pressure vessel system according to claim 3
wherein
the pressure detection spaces (31) are the interior spaces (27) delimited by the pressure vessels (19) and/or the flow space (44) delimited by the connecting line (12).

7. The pressure vessel system according to claim 2
wherein
the detection of the leak depends on the pressure data for the fluid of the at least two different pressure detection spaces (31), which data can be detected by the at least two pressure sensors (32), and by the chronological pressure progression in at least two different pressure detection spaces (31), being compared with one another.

8. The pressure vessel system according to claim 7,
wherein
the chronological pressure progression in at least two different pressure detection spaces (31), are compared with one another by comparing the chronological pressure progression in the at least two different pressure detection spaces (31), with at least one reference value and the leak is detected in an event of a deviation from the at least one reference value.

9. The pressure vessel system according to claim 8,
wherein
depending on a size of the deviation, a service note, a warning or an emergency message can be issued.

10. The pressure vessel system according to claim 5
wherein
the pressure in the at least two pressure detection spaces (31) can be detected while the closing elements (35) opening into the at least two pressure detection spaces (31) are closed.

11. The pressure vessel system according to claim 1,
wherein
the pressure vessel system (21) comprises a drainage system (41) for the at least one pressure vessel (19), which can be filled with the fluid, for releasing the fluid from the at least two pressure vessels (19) into an environment when a specified limit value of a discharge parameter is exceeded.

12. A method for operating a pressure vessel system (21) having a plurality of pressure vessels (19), which delimit interior spaces (27) as pressure detection spaces (31), for a motor vehicle (37), said method comprising the following steps:
introducing a fluid, as fuel, through at least one fluid opening (26) into at least one pressure vessel (19) by opening at least one shut-off element (34, 35) for the at least one fluid opening (26) so that the interior space (27) of the at least one pressure vessel (19) is filled with the fluid,
releasing the fluid as fuel through the at least one fluid opening (26) from the at least one pressure vessel (19) by opening the at least one shut-off element (34, 35) for the at least one fluid opening (26), so that the interior space (27) of the at least one pressure vessel (19) is emptied of the fluid,
storing the fluid in the interior spaces (27) of the pressure vessels (19) by the shut-off elements (34, 35) of the fluid openings (26) of the pressure vessels (19) remaining closed during a storage period,
detecting a pressure of the interior space (27) of the pressure vessel (19) using a pressure sensor (32),
determining a leak in the pressure vessel system (21) using data detected by the pressure sensor (32) via a computer unit (36),
wherein
the closing elements (34, 35), which are necessary for closing at least two pressure detection spaces (31), are always closed during the storage period and, during said storage period, the pressure of the fluid in the at least two pressure detection spaces (31) is detected in these at least two pressure detection spaces (31), and a leak in the pressure vessel system (21) is detected depending on the pressure data for the fluid in the at least two different pressure detection spaces (31), which data can be detected by the at least two pressure sensors (32).

13. The method according to claim 12,
wherein
the leak is detected depending on the pressure data detected by the at least two pressure sensors (32) in the at least two different pressure detection spaces (31) by comparing a chronological pressure progression in the at least two different pressure detection spaces (31).

14. The method according to claim 12,
wherein
a temperature of the fluid in the at least two different pressure detection spaces (31) is detected by temperature sensors (33), and the leak in the pressure vessel system (21) is detected depending on temperature data detected by the temperature sensors (33).

15. A motor vehicle (37) comprising:
a vehicle body (39),
a plurality of wheels (38),
a pressure vessel system (31),
at least one conversion unit (40) as a fuel cell unit (1) and/or an internal combustion engine, which can be operated using the combustible fluid from the pressure vessel system (21) in order to convert electrochemical energy of the combustible fluid into electrical and/or mechanical energy,
wherein
the pressure vessel system (21) is configured according to claim 1.

16. The method according to claim 14, wherein the temperature data detected by the temperature sensors (33) is a chronological temperature progression.

17. The pressure vessel system according to claim 11, wherein the discharge parameter is temperature and/or pressure.
